(19) United States
(12) Patent Application Publication
(10) Pub. No.: US 2026/0274171 A1
(43) Pub. Date: Sep. 17, 2026

(54) FIXING COMPONENT AND VEHICLE ROOF RACK

(71) Applicant: Zhijun He, Ezhou (CN)

(72) Inventor: Zhijun He, Ezhou (CN)

(21) Appl. No.: 19/681,205

(22) Filed: May 19, 2026

Related U.S. Application Data
(63) Continuation-in-part of application No. 19/244,037, filed on Jun. 20, 2025, now Pat. No. 12,654,623.
Application No. 19/244,037 is a continuation of application No. 18/461,518, filed on Sep. 6, 2023, now Pat. No. 12,679,279.

(51) Int. Cl. B60R 9/052; B60R 25/01

(52) U.S. Cl. CPC B60R 9/052; B60R 25/01

(57) ABSTRACT

A fixing component is configured to be mounted on a vehicle roof. The fixing component includes: a component body, a fixation element, and a connection assembly. The fixation element defines at least one fixation hole and a mating portion. The at least one fixation hole is configured to mount and fix the fixation element onto the vehicle roof. The connection assembly is configured to connect the component body with the mating portion, and is capable of being adjusted between a connected state and a separated state. In the connected state, the connection assembly is mated with the mating portion to enable the component body to be connected to the fixation element; and in the separated state, the connection assembly is detached from the mating portion.

### CROSS REFERENCE TO RELATED APPLICATIONS

This application is a continuation-in-part application of the U.S. patent application Ser. No. 19/244,037, filed on Jun. 20, 2025. The U.S. patent application Ser. No. 19/244,037 is a continuation application of the U.S. patent application Ser. No. 18/461,518, filed on Sep. 6, 2023. The disclosure of which is hereby incorporated by reference in their entireties.

### FIELD OF THE DISCLOSURE

The present disclosure relates to the field of vehicle roof racks, and particularly to a fixing component and a vehicle roof rack.

### BACKGROUND

In the art, a vehicle roof rack may be mounted on a vehicle roof via a fixing structure, such as screws. For this type of fixing structure, a large number of fixing structures may be needed for mounting, and a user may not mount or remove the vehicle roof rack conveniently. Furthermore, the fixing structure may not be exposed to an outside of the vehicle, further increasing difficulty in mounting or removing the vehicle roof rack. The entire mounting or removing process may be complicated, and therefore, the vehicle roof rack may not be suitable for daily use, and poor user experience may be caused.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

In some embodiments, a fixing component is configured to be mounted on a vehicle roof. The fixing component includes: a component body, a fixation element, and a connection assembly. The fixation element defines at least one fixation hole and a mating portion. The at least one fixation hole is configured to mount and fix the fixation element onto the vehicle roof. The connection assembly is configured to connect the component body with the mating portion, and is capable of being adjusted between a connected state and a separated state. In the connected state, the connection assembly is mated with the mating portion to enable the component body to be connected to the fixation element; and in the separated state, the connection assembly is detached from the mating portion.

In some embodiments, a vehicle roof rack includes: a connecting rod assembly a first fixing component, arranged at a first end of a connecting rod assembly; and a second fixing component, arranged at a second end of the connecting rod assembly. The connecting rod assembly is connected to the first fixing component and the second fixing component. Each of the first fixing component and the second fixing component is the fixing component in the above embodiments.

### BRIEF DESCRIPTION OF THE DRAWINGS

Illustrative embodiments of the present disclosure are described in detail below with reference to the attached drawing figures.

FIG. 1 is a schematic structural view of an entire fixing component according to some embodiments of the present disclosure.

FIG. 2 is an exploded view of the fixing component according to some embodiments of the present disclosure, where partial components are separated from each other.

FIG. 3 is a first cross-sectional view of the fixing component according to some embodiments of the present disclosure, where an operating element is in a first position.

FIG. 4 is a second cross-sectional view of the fixing component according to some embodiments of the present disclosure, where the operating element in a second position.

FIG. 5 is a first schematic view of the fixing component being in use according to some embodiments of the present disclosure.

FIG. 6 is a second schematic view of the fixing component being in use according to some embodiments of the present disclosure.

FIG. 7 is an exploded assembling view of the fixing component according to some embodiments of the present disclosure.

FIG. 8 is a schematic structural view of a component body according to some embodiments of the present disclosure.

FIG. 9 is a first schematic structural view of a bottom shell and an inner base according to some embodiments of the present disclosure.

FIG. 10 is a second schematic structural view of the bottom shell and the inner base according to some embodiments of the present disclosure.

FIG. 11 is a schematic structural view of a top shell according to some embodiments of the present disclosure.

FIG. 12 is a schematic structural view of a vehicle roof rack according to some embodiments of the present disclosure.

### REFERENCE NUMERALS IN THE DRAWINGS

1—component body; 10—bottom shell; 100—first surface; 101—shielding surface; 102—contacting surface; 103—first snap-fit portion; 104—second mounting hole; 11—top shell; 110—second surface; 111—second snap-fit portion; 113—third mounting hole; 12—first mounting hole; 121—first sub-hole; 122—second sub-hole; 130—receiving groove; 131—communication hole; 14—inner base; 15—external connection portion;
2—fixation element; 20—fixation hole; 21—mating portion; 22—positioning hole;
3—connection assembly; 30—locking rod; 31—connection portion; 32—operating element; 320—lock slot; 33—limiting structure;
4—locking element; 40—locking body; 41—lock tongue; 42—key hole;
5—positioning rod;
6—anti—slip pad;
7—fastener;
8—connection rod assembly;
1001—first fixing component; 1002—second fixing component.

### DETAILED DESCRIPTION

The following describes some non-limiting exemplary embodiments of the disclosure with reference to the accompanying drawings. The described embodiments are merely a part rather than all of the embodiments of the disclosure. All other embodiments obtained by a person of ordinary skill in the art based on the embodiments of the disclosure shall fall within the scope of the disclosure.

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “including” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be included in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

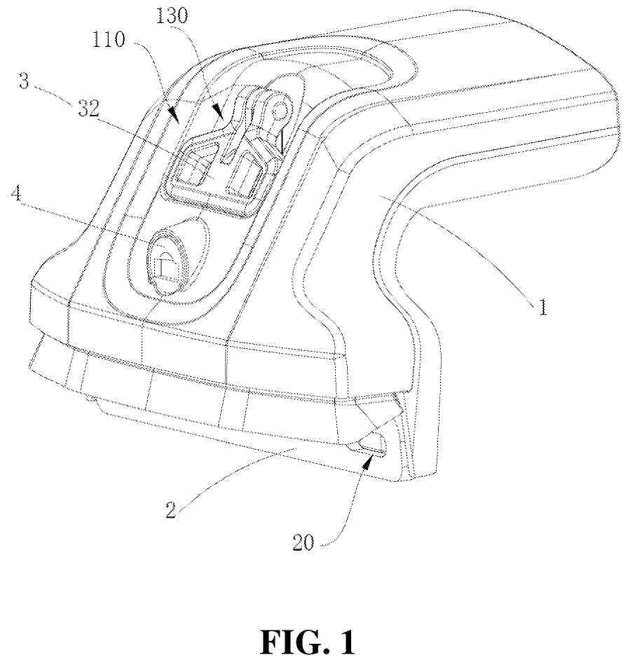

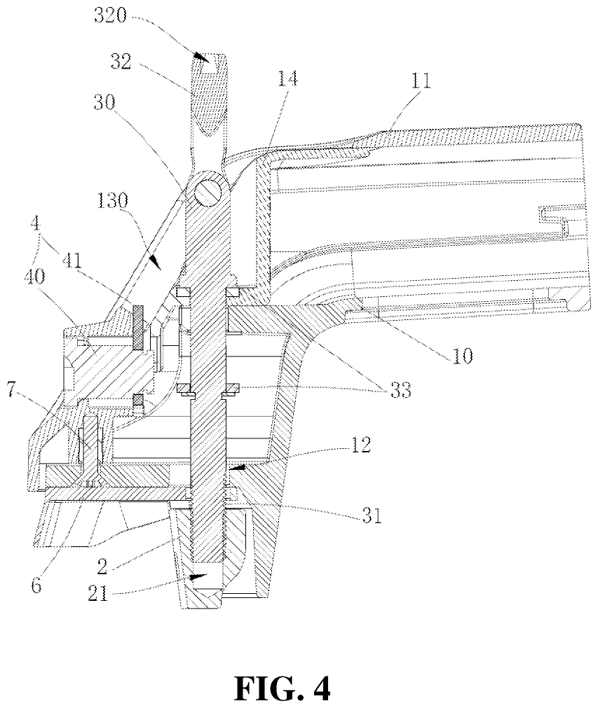

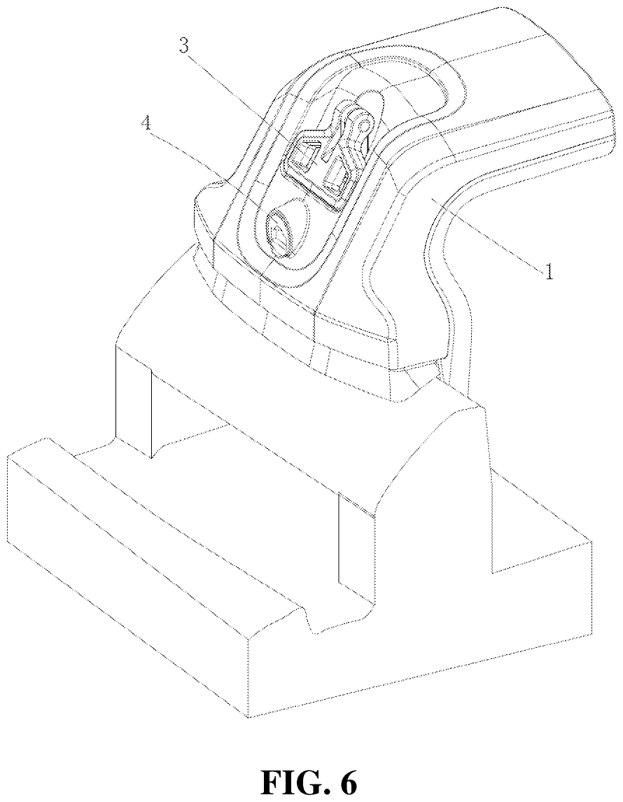

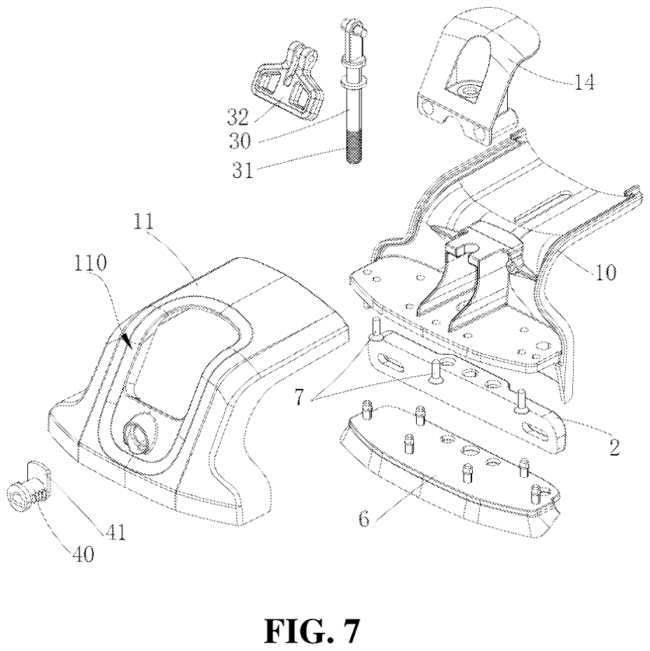

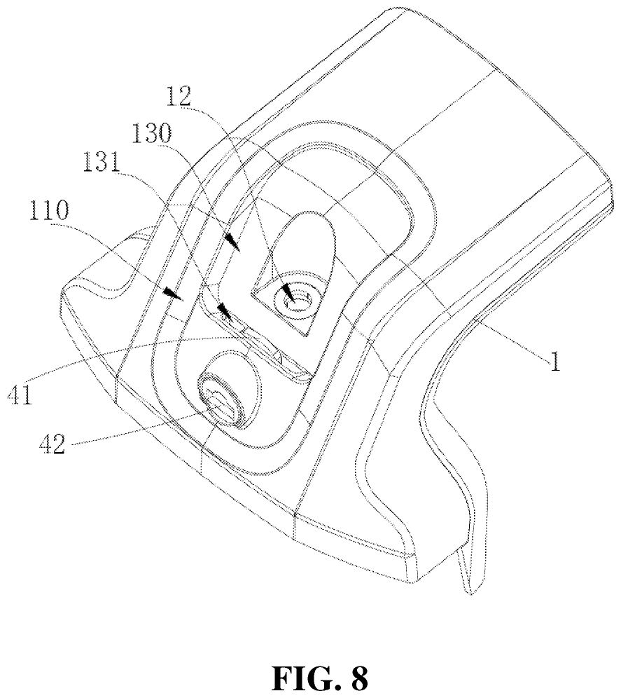

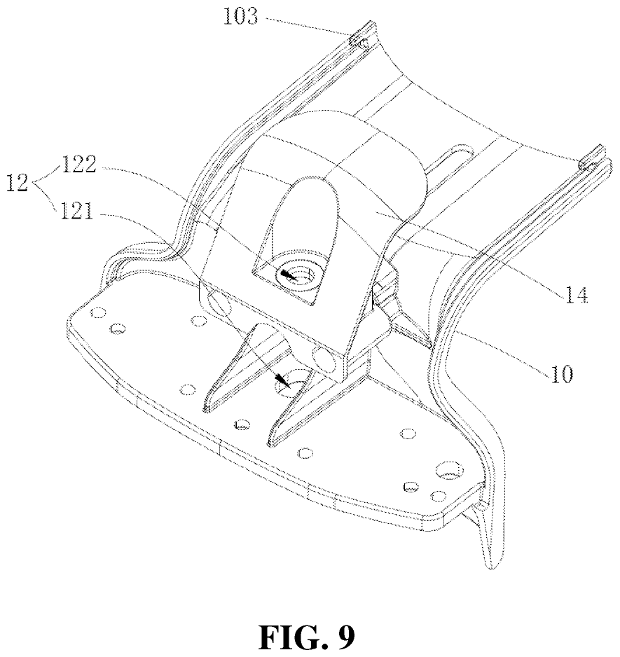

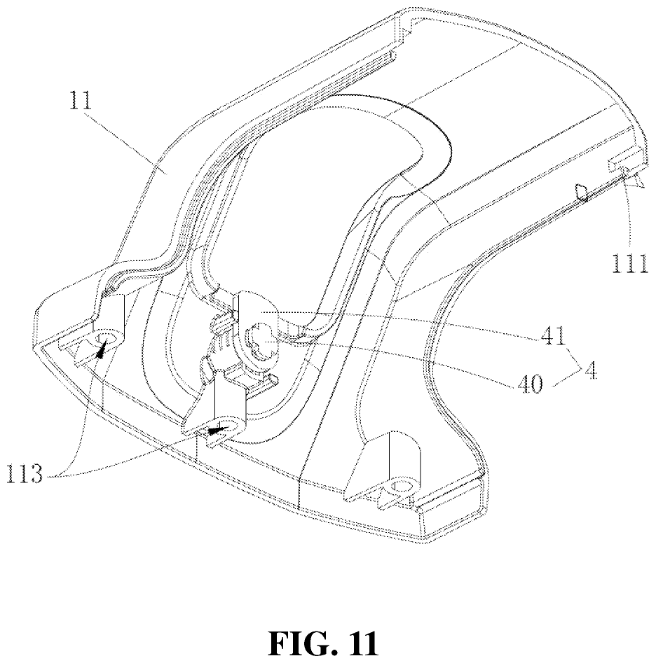

As shown in FIGS. 1-12, embodiments of the present disclosure may provide a fixing component and a vehicle roof rack. The vehicle roof rack may include one or more fixing components and a connecting rod assembly 8 connected to the one or more fixing components. In the following description, a vehicle roof rack including two fixing components will be described as an example by referring to the drawings.

It should be noted that the fixing component may be a part of the vehicle roof rack, and that is, the fixing component may be applied to the vehicle roof rack and may be configured to be fixedly connected to a vehicle roof.

As shown in FIGS. 1-11, each of the two fixing components may include: a component body 1, a fixation element 2, and a connection assembly 3. The fixation element 2 may define at least one fixation hole 20 and a mating portion 21. The fixation element 2 may be mounted and fixed onto the vehicle roof via the at least one fixation hole 20. The connection assembly 3 may be arranged on the component body 1 and may be capable of being adjusted between a connected state and a separated state. In the connected state, the connection assembly 3 may be mated with the mating portion 21 to enable the component body 1 to be connected to the fixation element 2, and the component body 1 may cover the at least one fixation hole 20. In the separated state, the connection assembly 3 may be detached from the mating portion 21.

Specifically, the fixation element 2 may be configured to be fixedly connected to the vehicle roof. One or more fixation holes 20 may be defined in the fixation element 2. In the present embodiment, the fixation element 2 defining two fixation holes 20 is described as an example. The fixation element 2 may be fixed to the vehicle roof by screws respectively passing through the two fixation holes 20. The fixation element 2 may be a sheet-shaped stamped metal element, having a certain thickness. When the component body 1 is removed from the vehicle roof, the fixation element 2 may not be removed from the vehicle roof together with the component body 1. The fixation element 2 may serve as a base for mounting the component body 1. The component body 1 may be configured as a shell element, having a certain strength, for example, the component body 1 may be made of metal or high-strength engineering plastic and may be configured to carry structures, such as the connecting rod assembly of the vehicle roof rack. The connection assembly 3 may be arranged on the component body 1 and may be detachably mated with the mating portion 21. The mating portion 21 may be a hole, a snap-fit structure, or any other structure that is suitable for being mated with the connection assembly 3. Due to the mating between the connection assembly 3 and the mating portion 21, in the connected state, the component body 1 may be quickly mounted onto the fixation element 2 and may be stably connected with the vehicle roof. In the separated state, the connection assembly 3 may be detached from the mating portion 21, allowing the component body 1 to be completely removed from the fixation element 2. In some embodiments, the connection assembly 3 may be an independent structure and may not be assembled on the component body 1, but may be configured as an additional structure. After the component body 1 is placed on the fixation element 2, the connection assembly 3 may be applied to be connected to the component body 1 and the mating portion 21 on the fixation element 2, such that the component body 1 may be fixed onto the fixation element 2.

In summary, by arranging the fixation element 2 to be fixed in advance to the vehicle roof, and by connecting the component body 1 with the fixation element 2 via the connection assembly 3, which may have an adjustable mating state, during mounting and removing the component body 1, the fixation element 2 may not be repeatedly disassembled from or assembled to the vehicle roof. In this way, the fixing component may be quickly mounted on or removed from the vehicle roof, such that the vehicle roof rack may be rapidly mounted on and detached from the vehicle roof. Mounting and detaching may be performed more efficiently, and the vehicle roof rack may be used more conveniently, and user experience may be improved.

As shown in FIGS. 1-11, in some embodiments, the fixing component may further include a locking element 4. The locking element 4 may be arranged on the component body 1 and configured to restrict or allow the connection assembly 3 to be adjusted between the connected state and the separated state.

The locking element 4 may be arranged on the component body 1 and may provide restriction on the connection assembly 3 to restrict a movement state of the connection assembly 3. In this way, the connection assembly 3 may be maintained in the connected state or in the separated state. The locking element 4 may be operated by a key to be unlocked, such that the locking element 4 may control adjustment of the state of the connection assembly 3. In the connected state, the connection assembly 3 may be mated with the mating portion 21, enabling the component body 1 to be connected to the fixation element 2, and at this moment, the component body 1 may at least cover the fixation hole 20. In this way, any external tool may not directly act on the screw in the fixation hole 20. The locking element 4 may be operated to release the restriction applied on the connection assembly 3, such that the connection assembly 3 may be detached from the mating portion 21 to be in the separated state, and the connection between the component body 1 and the fixation element 2 may be released, such that the component body 1, together with the connection assembly 3 and the locking element 4, may be completely removed from the fixation element 2.

According to the above embodiment, without changing a basic mounting manner in which the fixation element 2 is fixed to the vehicle roof by the screws, since the component body 1 may cover the fixation hole 20 and the connection assembly 3 may be mated with the mating portion 21, the fixation element 2 may be effectively protected. Therefore, the fixation element 2 and any structure connected thereto may not be directly disassembled, and therefore, theft of the vehicle roof rack may be avoided. In addition, due to controllable adjustment of the state of the connection assembly 3 by the locking element 4, the user may quickly mount the component body 1 to the vehicle roof or remove the component body 1 from the vehicle roof, without removing any structure covering the fixation hole 20 or without contacting the fixation hole 20. In this way, anti-theft performance may be achieved, and the vehicle roof rack may be operated conveniently.

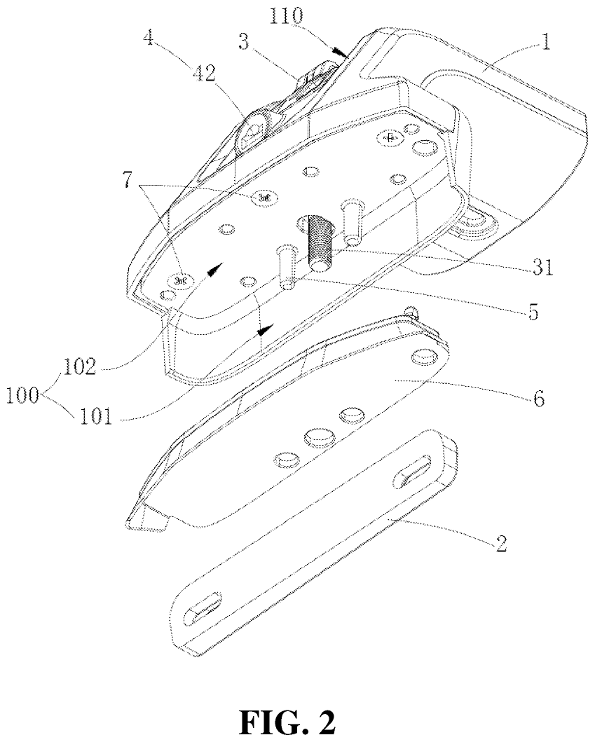

As shown in FIGS. 1 and 2, in some embodiments, the component body 1 may include a first surface 100 and a second surface 110 opposite to the first surface 100. The first surface 100 may cover the fixation hole 20. At least part of the connection assembly 3 may pass through the first surface 100 to be mated with the mating portion 21. An end of the connection assembly 3 away from the mating portion 21 may be at least partially exposed on the second surface 110. At least part of the locking element 4 may be exposed on the second surface 110.

Specifically, the first surface 100 may be a side of the component body 1 facing the fixation element 2. A shape of the first surface 100 may be adapted according to a contour of the fixation element 2. For example, the first surface 100 may be planar or may be a structure having a localized contacting portion. In this way, after mating, the first surface 100 may cover an area where the fixation hole 20 is located, preventing the fixation hole 20 from being directly exposed to an external environment. The second surface 110 may be opposite to the first surface 100, facing a user and serving as an operating interface. The end of the connection assembly 3 away from the mating portion 21 may be at least partially exposed on the second surface 110, enabling the user to quickly contact the connection assembly 3 to control the connection assembly 3 to establish or release the mating with the mating portion 21. The locking element 4 may be at least partially exposed on the second surface 110, such that the user may directly contact and operate the locking element 4. For example, the user may rotate, press, or toggle the locking element 4 to control a change in a state of the locking element 4. By arranging the locking element 4 on the second surface 110, the user may adjust the state of the connection assembly 3 without contacting the fixation element 2 or removing any structure covering the fixation element 2. In this way, in a case that the fixation hole 20 is covered by the first surface 100, the entire vehicle roof rack may be operated more conveniently and more efficiently.

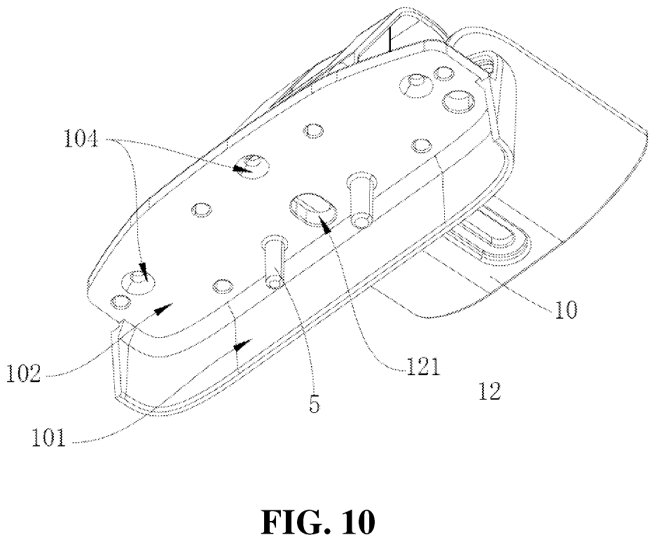

As shown in FIGS. 2 and 10, in some embodiments, the first surface 100 may include a shielding surface 101 and a contacting surface 102 connected to the shielding surface 101. An angle may be formed between the shielding surface 101 and the contacting surface 102. The contacting surface 102 may be configured to contact the fixation element 2. The shielding surface 101 may at least cover the at least one fixation hole 20. In the connected state, at least part of the connection assembly 3 may penetrate the contacting surface 102 to be mated with the mating portion 21.

According to the above embodiment, the first surface 100 may specifically be configured as a bent structure. The contacting surface 102 may be configured to contact a top surface of the fixation element 2, and may be a planar surface or a curved surface adapted to a contour of the fixation element 2, such that connection stability may be improved. The shielding surface 101 may extend from the contacting surface 102, and the angle may be formed between the shielding surface 101 and the contacting surface 102. In some embodiments, the angle may substantially be a right angle, such that lateral shielding for the fixation hole 20 in space may be provided, preventing the fixation hole 20 from being exposed from a lateral side. In the connected state, the connection assembly 3 may extend in a direction where the contacting surface 102 is penetrated. A part of the connection assembly 3 may pass through the contacting surface 102 to be mated with the mating portion 21 arranged on the fixation element 2. In this way, when the contacting surface 102 contacts the fixation element 2, the component body 1 may be connected to the fixation element 2. By arranging the shielding surface 101 and the contacting surface 102 which may work cooperatively, the fixation hole 20 may be simultaneously shielded from an upper side and the lateral side after the component body 1 is mounted to the fixation element 2. Furthermore, a stable penetrating mounting path may be provided for the connection assembly 3, such that the connection assembly 3 may have a clear movement and a clear force application interface during the connection assembly 3 being mated to or separated from the mating portion. In this way, an anti-theft effect may be achieved, structural stability and operational feasibility may be achieved.

As shown in FIGS. 1, 3, 4, 7, and 9, in some embodiments, the component body 1 may define a first mounting hole 12 penetrating the first surface 100 and the second surface 110. The connection assembly 3 may include a locking rod 30. The locking rod 30 may be arranged with a connection portion 31 for being mated with the mating portion 21. The locking rod 30 may be movably arranged in the first mounting hole 12. In the connected state, at least part of the connection portion 31 may extend out of the first mounting hole 12 to be mated with the mating portion 21, or at least part of the mating portion 21 may extend into the first mounting hole 12 to be mated with the connection portion 31.

Further, according to the above embodiment, the first mounting hole 12 may penetrate the component body 1 in a thickness direction thereof. An opening of one end of the first mounting hole 12 may be defined on the second surface 110. By penetrating downward, an opening of the other end of the first mounting hole 12 may be defined on the contacting surface 102 of the first surface 100. In this way, when the component body 1 contacts the fixation element 2, the first mounting hole 12 may be disposed correspondingly to the mating portion 21. The locking rod 30 may be arranged in the first mounting hole 12 and may be movable relative to the first mounting hole 12 along an axial direction of the first mounting hole 12. For example, the locking rod 30 may slide, or slide in combination with rotation, along the axial direction, such that, in the connected state, the connection portion 31 of the locking rod 30 may extend downward out of the first mounting hole 12 to be mated with the mating portion 21; and in the separated state, the locking rod 30 may move reversely in an opposite direction, enabling the connection portion 31 to be detached from the mating portion 21. In another embodiment, the mating portion 21 may extend upward into the first mounting hole 12, such that at least part of the mating portion 21 may be received in the first mounting hole 12 to be mated with the connection portion 31 of the locking rod 30.

As shown in FIGS. 1, 3, 4, 7, and 9, in some embodiments, one of the mating portion 21 and the connection portion 31 may be a threaded hole, and the other of the mating portion 21 and the connection portion 31 may be a screw rod mated with the threaded hole. Further, in the present embodiment, the mating portion 21 may be configured as the threaded hole, and the connection portion 31 may be configured as the screw rod structure extending coaxially with the locking rod 30. The screw rod may be made of metal, such as steel or stainless steel, such that the screw rod may have proper strength and wear resistance during repeated screwing. The threaded hole may be defined in the fixation element 2 and may be configured as an internal thread as needed. During transiting from the separated state to the connected state, the locking rod 30 may perform axial movement and rotation within the first mounting hole 12, such that the connection portion 31 may gradually extend out of the first mounting hole 12 to enter the threaded hole, and the connection portion 31 may be threadedly connected to the mating portion 21. In this way, the component body 1 may be fixed to the fixation element 2 and the vehicle roof reliably. During unlocking, a reverse operation may be performed. The screw rod may be moved out of the threaded hole, releasing the connection. In another embodiment, the mating portion 21 may be configured as the screw rod, and the connection portion 31 may be configured as the threaded hole mated with the mating portion 21. In this case, the mating portion 21 may extend into the first mounting hole 12 and may be screwed with the connection portion 31 to achieve the mating therebetween.

As shown in FIGS. 1-11, in some embodiments, the connection assembly 3 may further include an operating element 32. The operating element 32 may be connected to an end of the locking rod 30 away from the connection portion 31. At least part of the operating element 32 may be located on a side of the second surface 110. The locking element 4 may work cooperatively with the operating element 32 or the locking rod 30 to restrict or allow the connection assembly 3 to be adjusted between the connected state and the separated state.

Specifically, the operating element 32 may be a handle, a toggle, a knob, or any other structure on which the user may apply force. One end of the operating element 32 may be connected to the locking rod 30. In some embodiments, the operating element 32 may be coaxially arranged with the locking rod or may be connected to the locking rod via a connecting structure enabling force transmission. In this way, the user may drive the locking rod 30 to rotate by operating the operating element 32; and when necessary, axial movement may be performed to enable the connection portion 31 of the locking rod 30 to be screwed with or detached out of the mating portion 21. At least part of the operating element 32 may be located on the side of the second surface 110, such that a directly accessible operating area may be formed. The user may perform locking or unlocking without contacting the fixation element 2. The locking element 4 may be operatively coupled with the operating element 32 or the locking rod 30. For example, the locking element 4 may restrict the operating element 32 or the locking rod 30 by limiting, snap-fitting, or embedding. In the connected state, the locking element 4 may restrict the rotation and axial movement of the locking rod 30, preventing the connection portion 31 from accidentally detaching out of the mating portion 21. When the connection assembly 3 needs to be adjusted to be in the separated state, the restriction may be released, allowing the operating element 32 to drive the locking rod 30 to rotate to further drive the connection portion 31 to move into or out of the mating portion 21. According to the above embodiment, any operation on the connection assembly 3 may be performed on the side of the second surface 110. In this way, the anti-theft connection may be reliable, and mounting and removing the component body 1 may be performed more conveniently.

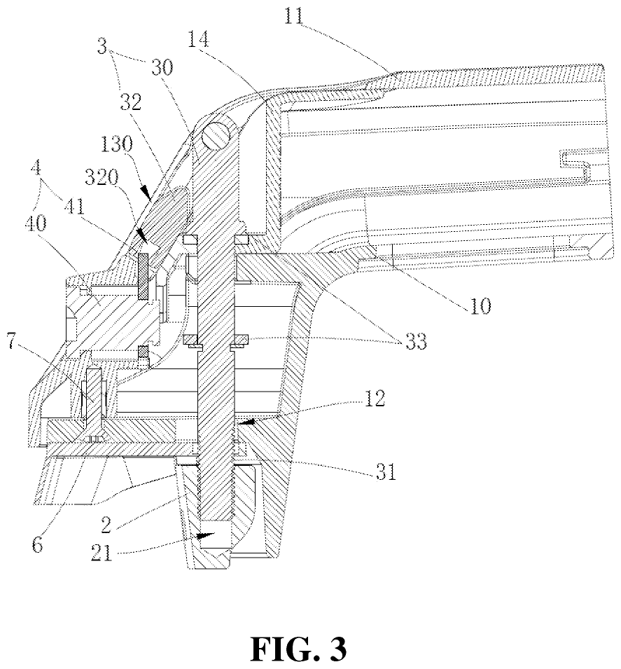

As shown in FIGS. 3, 4, and 8, in some embodiments, one end of the operating element 32 may be hinged to the locking rod 30, and the other end of the operating element 32 may define a lock slot 320. The operating element 32 may be arranged in a first position or in a second position. In the first position, the lock slot 320 may be disposed near the second surface 110 and may be mated with the locking element 4, such that the connection assembly 3 may be in the connected state. In the second position, the lock slot 320 may be disposed away from the second surface 110 and may be detached from the locking element 4, such that the connection assembly 3 may be in the separated state.

According to the above embodiment, the operating element 32 may be connected to the locking rod 30 via a hinged structure, allowing the operating element 32 to be transited between the first position and the second position. The lock slot 320 may be defined at an end of the operating element 32 away from a hinged end, and may be configured to be mated with the locking element 4 for achieving limiting. In the first position, the operating element 32 may contact or may be disposed near the second surface 110, and embedding or snap-fitting connection between the lock slot 320 and the locking element 4 may be formed, so as to restrict the operating element 32 from rotating relative to the locking rod 30, such that rotation and axial movement of the locking rod 30 may be restricted, and the connection assembly 3 may be maintained in the connected state. In the second position, the operating element 32 may rotate about the hinged end and may move away from the second surface 110. An extending direction of the operating element 32 may be substantially coaxial with the locking rod 30. At this moment, the locking element 4 may not be mated with the lock slot 320 and may not interfere with the operating element 32. The user may apply force to the locking rod 30 through the operating element 32, enabling the locking rod 30 to rotate and move axially, such that the connection portion 31 and the mating portion 21 may be screwed with or detached apart from each other. By transiting between the two positions, in the connected state, the operating element 32 may be stored and restricted; and in the separated state, a force-transmitting structure may be formed based on the operating element 32, such that anti-theft performance may be achieved, and the fixing component may be operated more conveniently.

As shown in FIGS. 3, 4, and 8, in some embodiments, the component body 1 may define a receiving groove 130 on the second surface 110. In the first position, at least part of the operating element 32 may be received in the receiving groove 130. Specifically, the receiving groove 130 may be defined on the second surface 110 and may be located spatially adjacent to or communicated with the first mounting hole 12. In this way, the end of the first mounting hole 12 near the second surface 110 may be received in the receiving groove 130. When the operating element 32 is in the first position, at least part of the operating element 32 may be embedded in the receiving groove 130, such that the operating element 32 may not protrude out of or only slightly protrude with respect to the second surface 110. Therefore, in appearance, no obvious protruding structure is formed. Since the operating element 32 is received in the receiving groove 130, an exposed part of the operating element 32 may be reduced and may be constrained by a surrounding structure, and it may be less likely for an external force to apply a large torque directly on the operating element 32. In this way, a risk of forcibly breaking the connection assembly 3 by toggling the operating element 32 with a large force may be reduced. Furthermore, in the first position, for the lock slot 320 defined in the operating element 32, a region of the lock slot 320 mated with the locking element 4 may be located at an inside of the receiving groove 130 or may be shielded by an edge of the receiving groove 130. In this way, a mating position between the locking element 4 and the lock slot 320 may not be directly exposed to the external environment, preventing the mating position from being disturbed or damaged by any external force.

As shown in FIGS. 3, 4, and 8, in some embodiments, the locking element 4 may include a locking body 40 and a lock tongue 41 arranged on the locking body 40. The locking body 40 may be rotatably mounted on the component body 1. An end of the locking body 40 away from the lock tongue 41 may define a key hole 42, and the key hole 42 may be exposed on the second surface 110. The lock tongue 41 may be located inside the component body 1. The component body 1 may define a communication hole 131 on the second surface 110 communicating with an interior of the component body 1. The lock tongue 41 may at least partially extend out of the second surface 110 through the communication hole 131 and then may be inserted into the lock slot 320. The communication hole 131 may be located in the receiving groove 130. In the first position, at least part of the operating element 32 may be received in the receiving groove 130, and the lock slot 320 may be communicated with the communication hole 131 correspondingly.

Specifically, the locking body 40 may be a cylindrical lock core, rotatably mounted inside the component body 1 and driven by a key to rotate. The lock tongue 41 may be disposed at one end of the locking body 40 and may be adjusted, as the locking body 40 rotates, between an extended position and a retracted position. The communication hole 131 may be formed inside the receiving groove 130, allowing the lock tongue 41 to reach the receiving groove 130 through the communication hole 131 to be mated with the lock slot 320 on the operating element 32. In the first position, the operating element 32 may be received in the receiving groove 130, and a body portion of the operating element 32 may shield the communication hole 131, such that the communication hole 131 may not be directly exposed. Furthermore, the lock slot 320 defined in the operating element 32 may correspond in spatial position to the communication hole 131 and may be communicated with the communication hole 131. At this moment, the lock tongue 41 may extend outward, through the communication hole 131, to be inserted into the lock slot 320, forming snap-fit connection for limiting the operating element 32. In this way, the operating element 32 may not rotate about the hinged end, such that the rotation and axial movement of the locking rod 30 may be limited, and the connection assembly 3 may be maintained in the connected state. When the connection assembly 3 needs to be adjusted to the separated state, a key may be inserted into the key hole 42 to drive the locking body 40 to rotate, causing the lock tongue 41 to leave out of the lock slot 320 and retract into the interior of the component body 1, such that limiting on the operating element 32 may be released. At this moment, the operating element 32 may rotate to reach the second position and drive the locking rod 30 to move, such that the connection assembly 3 may be switched from the connected state to the separated state.

As shown in FIGS. 2, 5, 6, and 10, in some embodiments, the fixing component may further include at least one positioning rod 5. The positioning rod 5 may protrude from the contacting surface 102 and may be spaced apart from the connection assembly 3. The fixation element 2 may define at least one positioning hole 22. The at least one positioning rod 5 may be respectively inserted into the at least one positioning hole 22.

Specifically, in the present embodiment, two positioning rods 5 may be arranged, and correspondingly, the fixation element 2 may define two positioning holes 22. The two positioning holes 22 and the mating portion 21 (such as the threaded hole) may be defined on a same surface (such as top surface) of the fixation element 2, and the mating portion 21 may be located between the two positioning holes 22. The positioning rod 5 may be a cylindrical protruding structure and may be inserted into the positioning hole 22, so as to achieve initial alignment between the component body 1 and the fixation element 2 during assembly, allowing the component body 1 to be quickly positioned on the fixation element 2, and preventing relative deviation of the connection assembly 3 during a screwing process. In this way, the connection portion 31 and the mating portion 21 may be easily aligned and mated with each other. After assembly, the insertion connection between the positioning rod 5 and the positioning hole 22 may provide additional limitation, enabling the component body 1 and the fixation element 2 to be more resistant against rotation and to be connected to each other more stably. In this way, the connection assembly 3 may be less likely to loosen when subjected to external forces.

As shown in FIGS. 3, 4, 7, 8, 9, 10, and 11, in some embodiments, the component body 1 may include a bottom shell 10 and a top shell 11 snap-fitted to the bottom shell 10. The first surface 100 may be disposed on a side of the bottom shell 10 away from the top shell 11. The second surface 110 may be disposed on a side of the top shell 11 away from the bottom shell 10. An end of the bottom shell 10 away from the first surface 100 may be arranged with a first snap-fit portion 103. The top shell 11 may be arranged with a second snap-fit portion 111 snap-fitted with the first snap-fit portion 103. The fixing component may further include a plurality of fasteners 7. The bottom shell 10 may define a plurality of second mounting holes 104 on the first surface 100. An end of the top shell 11 away from the second snap-fit portion 111 may define a plurality of third mounting holes 113. The plurality of fasteners 7, the plurality of second mounting holes 104, and the plurality of third mounting holes 113 may be in one-to-one correspondence with each other. Each of the plurality of fasteners 7 may pass through a corresponding one of the plurality of second mounting holes 104 and may then be fixedly connected to a corresponding one of the plurality of third mounting holes 113.

Specifically, after the bottom shell 10 and the top shell 11 are snap-fitted with each other, an internal cavity may be formed for accommodating a rotation space of the lock tongue 41 of the locking element 4 and a mounting space and a movement space of the connection assembly 3, such that various components may be effectively arranged inside the component body 1. The bottom shell 10 and the top shell 11 may be snap-fitted with each other at an end thereof, through the first snap-fit portion 103 and the second snap-fit portion 111, such that quick positioning and initial fixing may be achieved. At the other end of the bottom shell 10 and the top shell 11, the bottom shell 10 and the top shell 11 may be connected to each other via the plurality of fasteners 7. In this way, a reliable closed structure may be formed. In some embodiments, the plurality of second mounting holes 104 may be defined on the contacting surface 102 of the first surface 100. After the component body 1 is mounted onto the fixation element 2, the contacting surface 102 may contact the fixation element 2 and the vehicle roof, such that the plurality of fasteners 7 inserted in the plurality of second mounting holes 104 may be disposed between the component body 1 and the fixation element 2 and may not be directly exposed to the external environment. In this way, the bottom shell 10 and the top shell 11 may not be separated from each other by removing the plurality of fasteners 7. By arranging the snap-fit structure and the fasteners 7, internal components may be mounted easily; and after assembling, the fasteners 7 may be protected by structural shielding, such that structural strength may be improved, and anti-theft performance of the entire product may be improved.

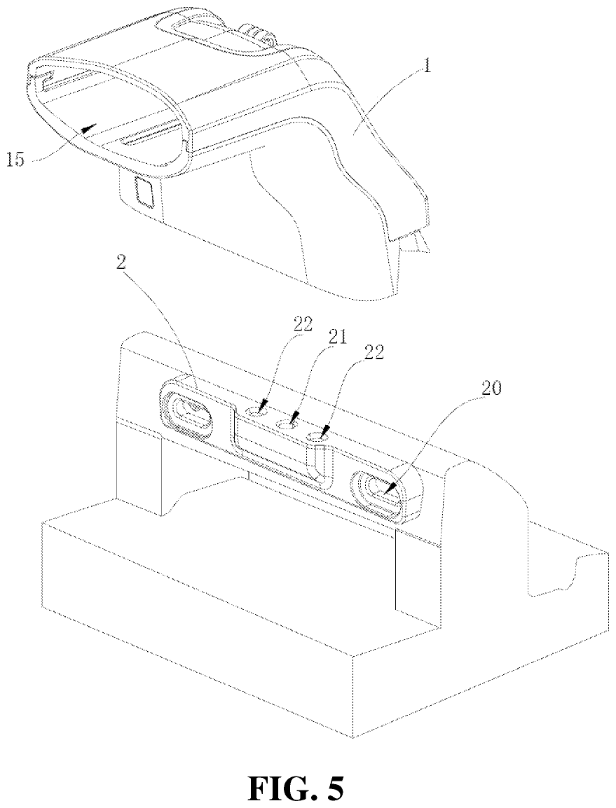

In addition, as shown in FIG. 5, the bottom shell 10 and the top shell 11 may enclose, at a side where the first snap-fit portion 103 and the second snap-fit portion 111 are arranged, to form an external connection portion 15. The external connection portion 15 may be used to be connected with the connecting rod assembly 8 of the vehicle roof rack or similar structures. For example, the connection may be achieved by plugging, snap-fitting, or fastening. In this way, the fixing component may be fixed to the fixation element 2 and may further serve as a connection node for the vehicle roof rack.

As shown in FIGS. 3, 4, 7, 8, 9, 10, and 11, in some embodiments, the fixing component may further include an anti-slip pad 6. The anti-slip pad 6 may be mounted on the first surface 100, and the anti-slip pad 6 may at least cover the plurality of fasteners 7. The anti-slip pad 6 may be mounted on the contacting surface 102.

Specifically, the anti-slip pad 6 may be made of rubber or other materials having a certain elasticity and a coefficient of friction. The anti-slip pad 6 may be configured to form a cushioning and friction-increasing interface among the component body 1, the fixation element 2 and the vehicle roof. The contacting surface 102 may define a plurality of through holes, and the anti-slip pad 6 may correspondingly be arranged with a plurality of protruding connecting structures, such as rubber T-shaped posts. The T-shaped posts may pass through the through holes and may be snap-fitted to a rear side of the contacting surface 102, such that the anti-slip pad 6 may be stably fixed to the contacting surface 102. In this way, the anti-slip pad 6 may be attached to the fixation element 2 or a surface of the vehicle roof after assembly, friction of contact surfaces may be improved, and local vibrations may be absorbed. Therefore, stability of the component body 1 and the fixation element 2 connected to the vehicle roof may be improved. Furthermore, the anti-slip pad 6 may cover the plurality of fasteners 7 arranged on the contacting surface 102, such that the plurality of fasteners 7 may be completely unexposed to the external environment, and the fasteners 7 may not be disassembled by direct contacting, further reducing a risk of damaging an overall structure of the product and a risk of the product being stolen.

As shown in FIGS. 3, 4, 7, 8, 9, 10, and 11, in some embodiments, the component body 1 may further include an inner base 14. The inner base 14 may be fixedly mounted on the bottom shell 10. The connection assembly 3 may be mounted on the inner base 14. In the connected state, at least part of the connection assembly 3 may pass through the first surface 100 to be mated with the mating portion 21. The locking rod 30 may be arranged with at least one limiting structure 33. The limiting structure 33 may be mated with the component body 1 to restrict the locking rod 30 from being detached from the first mounting hole 12.

Specifically, the first mounting hole 12 may be formed by a first sub-hole 121 defined on the first surface 100 of the bottom shell 10 and a second sub-hole 122 defined in the inner base 14. The first sub-hole 121 and the second sub-hole 122 may be coaxially located and may be spaced apart from each other. The first sub-hole 121 and the second sub-hole 122 may be communicated with each other. In this way, the first sub-hole 121 and the second sub-hole 122 may cooperatively form a guide channel for the locking rod 30 to move axially. The locking rod 30 may be rod-shaped and may slide axially and rotate within the first mounting hole 12 to enable the connection portion 31 to be mated with or detached from the mating portion 21. Two limiting structures 33 may be arranged and may be spaced apart from each other along an axial direction of the locking rod 30. One of the two limiting structures 33 may be disposed at an end of the second sub-hole 122 away from the first sub-hole 121 (such as above the inner base 14). The other one of the two limiting structures 33 may be disposed at an end of the second sub-hole 122 near the first sub-hole 121 (such as below the inner base 14). When the locking rod 30 moves toward the fixation element 2 and is being mated with the mating portion 21, the limiting structure 33 disposed above the inner base 14 may abut against the inner base 14, so as to restrict the locking rod 30 from continuing to move downward, preventing the connection portion 31 from being excessively inserted into the fixation element 2. When the locking rod 30 moves away from the fixation element 2, the other limiting structure 33 disposed below the inner base 14 may abut against the inner base 14, so as to restrict the locking rod 30 from moving upward to be detached from the first mounting hole 12, preventing the locking rod 30 from being completely pulled out. By arranging the two limiting structures 33 to achieve limitation in two directions, a range of the axial movement of the locking rod 30 may be clearly restricted, such that connection reliability may be ensured, and the entire product may be used more stably and safely.

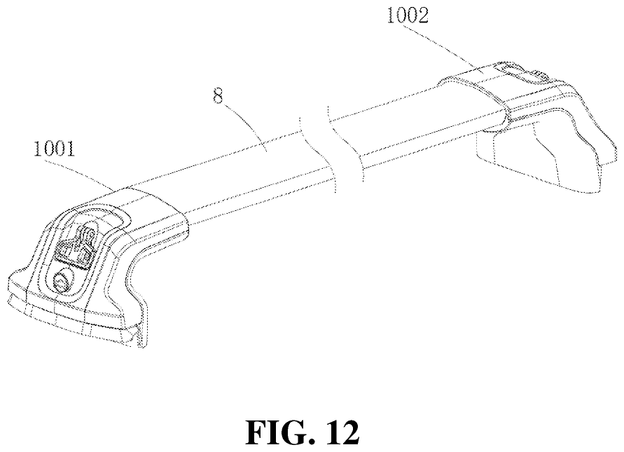

As shown in FIG. 12, the present disclosure may further provide a vehicle roof rack, which may include: a first fixing component 1001, a second fixing component 1002, and a connecting rod assembly 8. The first fixing component 1001 may be arranged at a first end of the connecting rod assembly 8. The second fixing component 1002 may be arranged at a second end of the connecting rod assembly 8. The connecting rod assembly 8 may be connected to the first fixing component 1001 and the second fixing component 1002. Each of the first fixing component 1001 and the second fixing component 1002 may be the fixing component according to the previous embodiments. The first fixing component 1001 and the second fixing component 1002 may be arranged symmetrically with respect to the connecting rod assembly 8.

Specifically, the connecting rod assembly 8 may be connected to each of the first fixing component 1001 and the second fixing component 1002 via an external connection portion 15 arranged on the component body 1. For example, the connection may be achieved by plugging, snapping, or fastening, such that the connecting rod assembly 8 and the fixing components may form a stable overall structure. By arranging fixing components respectively at two ends of the connecting rod assembly 8 and arranging the fixing components in a symmetrical manner, the vehicle roof rack may be subject to forces in a balanced manner when mounted on the vehicle roof, providing a stable structure. Furthermore, by arranging the fixing component to cover the fixation element 2 and arranging the locking structure, reliable connection and anti-theft protection between the connecting rod assembly 8 and the vehicle roof may be provided, such that a load-bearing capacity of the vehicle roof may be achieved, and the vehicle roof rack may be used safely and reliably.

According to the above embodiments, by arranging the fixation element to be fixed in advance to the vehicle roof, and by connecting the component body with the fixation element via the connection assembly, which may have an adjustable mating state, during mounting and removing the component body, the fixation element may not be repeatedly disassembled from or assembled to the vehicle roof. In this way, the fixing component may be quickly mounted on or removed from the vehicle roof, such that the vehicle roof rack may be rapidly mounted on and detached off from the vehicle roof. Mounting and detaching may be performed more efficiently, and the vehicle roof rack may be used more conveniently, and user experience may be improved.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

What is claimed is:

1. A fixing component, configured to be mounted on a vehicle roof, the fixing component comprising:
a component body;
a fixation element, defining at least one fixation hole and a mating portion, wherein, the at least one fixation hole is configured to mount and fix the fixation element onto the vehicle roof; and
a connection assembly, being capable of being adjusted between a connected state and a separated state; wherein, in the connected state, the connection assembly is mated with the mating portion to enable the component body to be connected to the fixation element; and in the separated state, the connection assembly is detached from the mating portion.

2. The fixing component according to claim 1, wherein, the connection assembly is arranged on the component body; the component body comprises a first surface and a second surface opposite to the first surface; the first surface is configured to cover the at least one fixation hole; at least part of the connection assembly passes through the first surface to be mated with the mating portion, and an end of the connection assembly away from the mating portion is at least partially exposed on the second surface.

3. The fixing component according to claim 2, wherein, the first surface comprises a shielding surface and a contacting surface connected to the shielding surface, an angle is formed between the shielding surface and the contacting surface;
in the connected state, the contacting surface contacts the fixation element, and the shielding surface at least covers the at least one fixation hole; and
in the connected state, at least part of the connection assembly passes through the contacting surface to be mated with the mating portion.

4. The fixing component according to claim 2, wherein, the component body defines a first mounting hole penetrating the first surface and the second surface;
the connection assembly comprises a locking rod, the locking rod is arranged with a connection portion for being mated with the mating portion, and the locking rod is movably arranged in the first mounting hole; and
in the connected state, at least part of the connection portion extends out of the first mounting hole and is mated with the mating portion, or at least part of the mating portion extends into the first mounting hole and is mated with the connection portion.

5. The fixing component according to claim 4, wherein, one of the mating portion and the connection portion is a threaded hole, and the other one of the mating portion and the connection portion is a screw rod mated with the threaded hole.

6. The fixing component according to claim 4, wherein, the connection assembly further comprises an operating element, the operating element is connected to an end of the locking rod away from the connection portion, and at least part of the operating element is disposed on a side of the second surface.

7. The fixing component according to claim 6, further comprising a locking element, arranged on the component body; wherein, the locking element is mated with the operating element or the locking rod, so as to restrict or allow the connection assembly to be switched between the connected state and the separated state.

8. The fixing component according to claim 7, wherein, one end of the operating element is hinged to the locking rod, and the other end of the operating element defines a lock slot;
the operating element is capable of being arranged in a first position or in a second position; in the first position, the lock slot is disposed near the second surface and is mated with the locking element to enable the connection assembly to be in the connected state; and
in the second position, the lock slot is disposed away from the second surface and is detached from the locking element, so as to enable the connection assembly to be in the separated state.

9. The fixing component according to claim 8, wherein, the component body defines a receiving groove on the second surface; in the first position, at least part of the operating element is received in the receiving groove.

10. The fixing component according to claim 8, wherein, the locking element comprises a locking body and a lock tongue arranged on the locking body, the locking body is rotatably mounted on the component body;
an end of the locking body away from the lock tongue defines a key hole, the key hole is exposed on the second surface; and
the lock tongue is arranged inside the component body; the component body defines a communication hole on the second surface, communicated with an interior of the component body; the lock tongue is capable of at least partially extending out of the second surface through the communication hole and then inserted into the lock slot.

11. The fixing component according to claim 10, wherein, the component body defines a receiving groove on the second surface; the communication hole is located in the receiving groove; in the first position, at least part of the operating element is received in the receiving groove, and the lock slot is communicated with the communication hole.

12. The fixing component according to claim 1, further comprising a locking element, arranged on the component body and mated with the connection assembly to restrict or allow the connection assembly to switch between the connected state and the separated state.

13. The fixing component according to claim 4, wherein, the locking rod is arranged with at least one limiting structure, mated with the component body, so as to restrict the locking rod from being detached from the first mounting hole.

14. The fixing component according to claim 3, further comprising at least one positioning rod, protruding from the contacting surface and being spaced apart from the connection assembly; wherein, the fixation element defines at least one positioning hole; the at least one positioning rod is capable of being inserted into the at least one positioning hole.

15. The fixing component according to claim 3, further comprising an anti-slip pad, mounted on the contacting surface.

16. The fixing component according to claim 2, wherein, the component body comprises a bottom shell and a top shell snap-fitted to the bottom shell; the first surface is disposed on a side of the bottom shell away from the top shell; the second surface is disposed on a side of the top shell away from the bottom shell;
an end of the bottom shell away from the first surface is arranged with a first snap-fit portion; the top shell is arranged with a second snap-fit portion mated with the first snap-fit portion; and
the fixing component further comprises a plurality of fasteners; the bottom shell defines a plurality of second mounting holes on the first surface; an end of the top shell away from the second snap-fit portion defines a plurality of third mounting holes; the plurality of fasteners, the plurality of second mounting holes, and the plurality of third mounting holes are in one-to-one correspondence with each other; each of the plurality of fasteners passes through a corresponding one of the plurality of second mounting holes and is fixedly connected to a corresponding one of the plurality of third mounting holes.

17. The fixing component according to claim 16, further comprising an anti-slip pad, mounted on the first surface, wherein, the anti-slip pad at least covers the plurality of fasteners.

18. The fixing component according to claim 16, wherein, the component body further comprises an inner base, the inner base is fixedly mounted on the bottom shell; the connection assembly is mounted on the inner base; in the connected state, at least part of the connection assembly passes through the first surface and is mated with the mating portion.

19. A vehicle roof rack, comprising:
a connecting rod assembly;
a first fixing component, arranged at a first end of the connecting rod assembly;
a second fixing component, arranged at a second end of the connecting rod assembly;
wherein, the connecting rod assembly is connected to the first fixing component and the second fixing component; and each of the first fixing component and the second fixing component is the fixing component according to claim 1.

20. The vehicle roof rack according to claim 19, wherein, the first fixing component and the second fixing component are arranged symmetrically with respect to the connecting rod assembly.
